(19) United States
(12) Patent Application Publication
(10) Pub. No.: US 2013/0095455 A1
(43) Pub. Date: Apr. 18, 2013

(54) POLICE TRAINING SYSTEMS FOR TRAINING TWO GROUPS OF POLICE OFFICERS EQUIPPED WITH STATE OF THE ART TECHNOLOGIES

(71) Applicant: YAT WAI EDWIN KWONG, Hong Kong (HK)

(72) Inventor: YAT WAI EDWIN KWONG, Hong Kong (HK)

(21) Appl. No.: 13/275,501

(22) Filed: Oct. 18, 2011

(51) Int. Cl. G09B 19/00

(52) U.S. Cl. 434/219

(57) ABSTRACT

Systems are provided for training two groups of police officers equipped with state of the art technologies. In one embodiment, a system is provided. The system includes a server comprising a virtual machine, and a mobile device held by an officer, wherein the officer belongs to a first group. The system further includes an enemy mobile device held by an officer belonging to a second group, wherein the second group is an enemy group of the first group. The system further includes a friendly mobile device held by another officer belong to the first group.

### FIELD OF THE INVENTION

This invention generally relates to police training systems for training two groups of police officers equipped with state of the art technologies. Specifically, but not limited to, this invention relates to receiving instructions from any of the two groups of police officers; tracing statuses of the two groups of the police officers, the statuses including location and movement of the police officers; and selectively displaying the statuses of the two groups of the police officers to any of the two groups of police officers.

### BACKGROUND OF THE INVENTION

Training of policemen is crucial in many aspects for the police force. For example, new recruits are required to be trained extensively to make sure the newly acquired policemen are well-trained. Those who are already serving in the police force will periodically be exercised as much as possible. Therefore, a training scheme for officers is in need. Emerging technologies are available to policemen requiring extensive training. In training, officers participate in mock-up exercises. In a typical exercise, one group of officials plays the role of police officers whereas another group of officials play the role of criminals. The officers performing the role of criminals may be hidden in a number of places within a confined area. The officers, meanwhile, need to locate the hidden officers. The whole scenario is similar to a hide and seek game for the training officers.

In real life scenarios, nowadays, policemen are equipped with technological devices. Such electronic devices allow officers to communicate with each other. Moreover, the devices may allow the officers to locate and chase the suspecting criminals. There is a need to create such an environment for officers in training.

### SUMMARY OF THE INVENTION

A police training system for training two groups of police officers equipped with state of the art technologies, comprising: a server comprising a virtual machine that receives instructions from any of the two groups of police officers; traces statuses of the two groups of the police officers, the statuses including: location and movement of the police officers; and selectively displays the statuses of the two groups of the police officers to any of the two groups of police officers; a mobile device held by an officer, wherein the officer belongs to a first group, wherein the mobile device comprises a GPS receiver to locate current location of the mobile device; searches if any enemy mobile devices are within proximity of the officer; warns the officer if any enemy mobile devices are approaching the officer; and locks on to any specific enemy mobile devices that are found in the proximity of the officer; an enemy mobile device held by an officer belonging to a second group, wherein the second group is an enemy group of the first group comprising a GPS receiver; a friendly mobile device held by another officer belong to the first group wherein the friendly mobile device comprises a GPS receiver; and a processor and a memory of the server.

In one embodiment, the embodied method comprises receiving a request from the mobile device held by the officer to seek for nearby enemies; prompting relevant mobile devices for the statuses regarding the locations of the relevant mobile devices; and receiving responses from the relevant mobile devices; and sending information to the mobile device held by the officer in response to the request.

In another embodiment, the method may comprise receiving a request from the mobile device held by the officer to seek for nearby enemies; prompting relevant mobile devices for the statuses regarding the locations of the relevant mobile devices, wherein the enemy mobile device, being one of the prompted enemy mobile devices from the server: is configured to intermittently receive a current location of the enemy mobile device based on the GPS receiver included in the enemy mobile device, in order to increase unpredictability of the exact location of the enemy mobile device for purposes of increasing challenges of seeking the enemies; and returns the current location of the enemy mobile device to the server, when the enemy mobile device receives the current location, or else returns a prior location of the enemy mobile device detected by the GPS receiver at an earlier time; receiving responses from the relevant mobile devices, including the statues from the enemy mobile device; and sending information to the mobile device held by the officer in response to the request, including the location of the enemy mobile device.

In yet another embodiment, the method may comprise receiving a request from the mobile device held by the officer to seek for nearby enemies; prompting relevant mobile devices for the statuses regarding the locations of the relevant mobile devices, wherein the enemy mobile device, being one of the prompted enemy mobile devices from the server: is configured to only intermittently receive a current location of the enemy mobile device based on the GPS receiver included in the enemy mobile device, in order to increase unpredictability of the exact location of the enemy mobile device for purposes of increasing challenges of seeking the enemies; and returns the current location of the enemy mobile device to the server, when the enemy mobile device receives the current location, or else returns a prior location of the enemy mobile device detected by the GPS receiver at an earlier time; receiving responses from the relevant mobile devices, including the statues from the enemy mobile device; processing the responses, including: comparing a distance between the location of the enemy mobile device and the mobile device; and when the distance falls within a certain range, sending location information to the mobile device held by the officer in response to the request to indicate that the enemy mobile device is being within range.

Alternatively, the exemplified method comprises receiving a request from the mobile device held by the officer to seek for nearby enemies; prompting relevant mobile devices for the statuses regarding the locations of the relevant mobile devices, wherein the enemy mobile device, being one of the prompted enemy mobile devices from the server: is configured to only intermittently receive a current location of the enemy mobile device based on the GPS receiver included in the enemy mobile device, in order to increase unpredictability of the exact location of the enemy mobile device for purposes of increasing challenges of seeking the enemies; and returns the current location of the enemy mobile device to the server, when the enemy mobile device receives the current location, or else returns a prior location of the enemy mobile device detected by the GPS receiver at an earlier time; receiving responses from the relevant mobile devices, including the statues from the enemy mobile device; and processing the responses, including: comparing a distance between the location of the enemy mobile device and the mobile device; when the distance falls within a certain range, sending location information to the mobile device held by the officer in response to the request to indicate that the enemy mobile device is being within range; monitoring the enemy mobile device on behalf of the mobile device, when the distance falls within the certain range, wherein the monitoring includes: monitoring whether the enemy mobile device is approaching at a direction to the mobile device, by prompting the GPS included in the enemy mobile device; if the enemy mobile device is approaching at the direction to the mobile device, sending an alert to the mobile device, wherein the alert includes information regarding the direction approaching by the enemy device with respect to the mobile device; and seeking help from other friendly mobile devices nearby, and if found, alerting the mobile device regarding the location of the friendly mobile device.

### BRIEF DESCRIPTION OF THE DRAWINGS

FIG. 1 illustrates an exemplary police training system, consistent with embodiments of the present invention.

### DETAILED DESCRIPTION

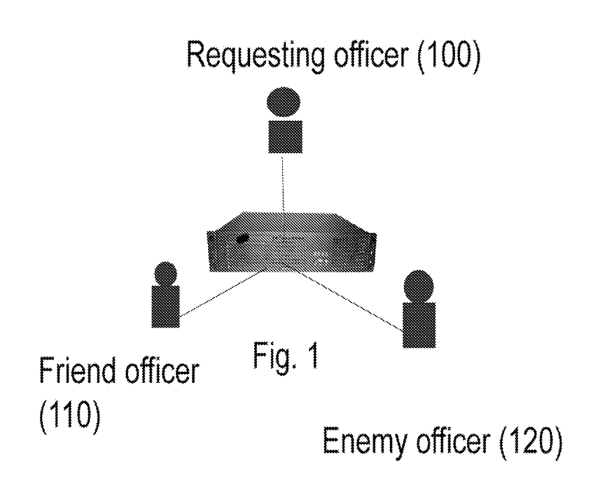

A police training system for training two groups of police officers equipped with state of the art technologies can be illustrated in FIG. 1, which comprising a server comprising a virtual machine that receives instructions from any of the two groups of police officers; traces statuses of the two groups of the police officers, the statuses including: location and movement of the police officers; and selectively displays the statuses of the two groups of the police officers to any of the two groups of police officers; a mobile device held by an officer, wherein the officer belongs to a first group, wherein the mobile device comprises a GPS receiver to locate current location of the mobile device; searches if any enemy mobile devices are within proximity of the officer; warns the officer if any enemy mobile devices are approaching the officer; and locks on to any specific enemy mobile devices that are found in the proximity of the officer; an enemy mobile device held by an officer belonging to a second group, wherein the second group is an enemy group of the first group comprising a GPS receiver; a friendly mobile device held by another officer belong to the first group wherein the friendly mobile device comprises a GPS receiver; and a processor and a memory of the server, wherein the memory stores instructions that are executed by a method, the method comprises: receiving a request from the mobile device held by the officer to seek for nearby enemies; prompting relevant mobile devices for the statuses regarding the locations of the relevant mobile devices; receiving responses from the relevant mobile devices; and sending information to the mobile device held by the officer in response to the request.

The police training system may be implemented in different ways. For example, the two groups of police officers can be equipped with state of the art technologies, comprising: a server comprising a virtual machine that receives instructions from any of the two groups of police officers; traces statuses of the two groups of the police officers, the statuses including: location and movement of the police officers; and selectively displays the statuses of the two groups of the police officers to any of the two groups of police officers; a mobile device held by an officer, wherein the officer belongs to a first group, wherein the mobile device comprises a GPS receiver to locate current location of the mobile device; searches if any enemy mobile devices are within proximity of the officer; warns the officer if any enemy mobile devices are approaching the officer; and locks on to any specific enemy mobile devices that are found in the proximity of the officer; an enemy mobile device held by an officer belonging to a second group, wherein the second group is an enemy group of the first group comprising a GPS receiver; a friendly mobile device held by another officer belong to the first group wherein the friendly mobile device comprises a GPS receiver; and a processor and a memory of the server, wherein the memory stores instructions that are executed by a method, the method comprises: receiving a request from the mobile device held by the officer to seek for nearby enemies; prompting relevant mobile devices for the statuses regarding the locations of the relevant mobile devices, wherein the enemy mobile device, being one of the prompted enemy mobile devices from the server: is configured to intermittently receive a current location of the enemy mobile device based on the GPS receiver included in the enemy mobile device, in order to increase unpredictability of the exact location of the enemy mobile device for purposes of increasing challenges of seeking the enemies; and returns the current location of the enemy mobile device to the server, when the enemy mobile device receives the current location, or else returns a prior location of the enemy mobile device detected by the GPS receiver at an earlier time; receiving responses from the relevant mobile devices, including the statues from the enemy mobile device; and sending information to the mobile device held by the officer in response to the request, including the location of the enemy mobile device.

In another example, the training two groups of police officers are equipped with state of the art technologies, comprising: a server comprising a virtual machine that receives instructions from any of the two groups of police officers; traces statuses of the two groups of the police officers, the statuses including: location and movement of the police officers; and selectively displays the statuses of the two groups of the police officers to any of the two groups of police officers; a mobile device held by an officer, wherein the officer belongs to a first group, wherein the mobile device comprises a GPS receiver to locate current location of the mobile device; searches if any enemy mobile devices are within proximity of the officer; warns the officer if any enemy mobile devices are approaching the officer; and locks on to any specific enemy mobile devices that are found in the proximity of the officer; an enemy mobile device held by an officer belonging to a second group, wherein the second group is an enemy group of the first group comprising a GPS receiver; a friendly mobile device held by another officer belong to the first group wherein the friendly mobile device comprises a GPS receiver; and a processor and a memory of the server, wherein the memory stores instructions that are executed by a method, the method comprises: receiving a request from the mobile device held by the officer to seek for nearby enemies; prompting relevant mobile devices for the statuses regarding the locations of the relevant mobile devices, wherein the enemy mobile device, being one of the prompted enemy mobile devices from the server: is configured to only intermittently receive a current location of the enemy mobile device based on the GPS receiver included in the enemy mobile device, in order to increase unpredictability of the exact location of the enemy mobile device for purposes of increasing challenges of seeking the enemies; and returns the current location of the enemy mobile device to the server, when the enemy mobile device receives the current location, or else returns a prior location of the enemy mobile device detected by the GPS receiver at an earlier time; receiving responses from the relevant mobile devices, including the statues from the enemy mobile device; processing the responses, including: comparing a distance between the location of the enemy mobile device and the mobile device; and when the distance falls within a certain range, sending location information to the mobile device held by the officer in response to the request to indicate that the enemy mobile device is being within range.

In yet another example, the training two groups of police officers are equipped with state of the art technologies, comprising: a server comprising a virtual machine that receives instructions from any of the two groups of police officers; traces statuses of the two groups of the police officers, the statuses including: location and movement of the police officers; and selectively displays the statuses of the two groups of the police officers to any of the two groups of police officers; a mobile device held by an officer, wherein the officer belongs to a first group, wherein the mobile device comprises a GPS receiver to locate current location of the mobile device; searches if any enemy mobile devices are within proximity of the officer; warns the officer if any enemy mobile devices are approaching the officer; and locks on to any specific enemy mobile devices that are found in the proximity of the officer; an enemy mobile device held by an officer belonging to a second group, wherein the second group is an enemy group of the first group comprising a GPS receiver;

Further, a friendly mobile device may be held by another officer belong to the first group wherein the friendly mobile device comprises a GPS receiver; and a processor and a memory of the server, wherein the memory stores instructions that are executed by a method, the method comprises: receiving a request from the mobile device held by the officer to seek for nearby enemies; prompting relevant mobile devices for the statuses regarding the locations of the relevant mobile devices, wherein the enemy mobile device, being one of the prompted enemy mobile devices from the server: is configured to only intermittently receive a current location of the enemy mobile device based on the GPS receiver included in the enemy mobile device, in order to increase unpredictability of the exact location of the enemy mobile device for purposes of increasing challenges of seeking the enemies; and returns the current location of the enemy mobile device to the server, when the enemy mobile device receives the current location, or else returns a prior location of the enemy mobile device detected by the GPS receiver at an earlier time; receiving responses from the relevant mobile devices, including the statues from the enemy mobile device; and processing the responses, including: comparing a distance between the location of the enemy mobile device and the mobile device; when the distance falls within a certain range, sending location information to the mobile device held by the officer in response to the request to indicate that the enemy mobile device is being within range; monitoring the enemy mobile device on behalf of the mobile device, when the distance falls within the certain range, wherein the monitoring includes: monitoring whether the enemy mobile device is approaching at a direction to the mobile device, by prompting the GPS included in the enemy mobile device; if the enemy mobile device is approaching at the direction to the mobile device, sending an alert to the mobile device, wherein the alert includes information regarding the direction approaching by the enemy device with respect to the mobile device; and seeking help from other friendly mobile devices nearby, and if found, alerting the mobile device regarding the location of the friendly mobile device.

What is claimed is:

1. A police training system for training two groups of police officers equipped with state of the art technologies, comprising:
a server comprising a virtual machine that
receives instructions from any of the two groups of police officers;
traces statuses of the two groups of the police officers, the statuses including:
location and movement of the police officers; and
selectively displays the statuses of the two groups of the police officers to any of the two groups of police officers;
a mobile device held by an officer, wherein the officer belongs to a first group, wherein the mobile device
comprises a GPS receiver to locate current location of the mobile device;
searches if any enemy mobile devices are within proximity of the officer;
warns the officer if any enemy mobile devices are approaching the officer; and
locks on to any specific enemy mobile devices that are found in the proximity of the officer;
an enemy mobile device held by an officer belonging to a second group, wherein the second group is an enemy group of the first group comprising a GPS receiver;
a friendly mobile device held by another officer belong to the first group wherein the friendly mobile device comprises a GPS receiver; and
a processor and a memory of the server.

2. The system of claim 1, wherein the method comprises:
receiving a request from the mobile device held by the officer to seek for nearby enemies;
prompting relevant mobile devices for the statuses regarding the locations of the relevant mobile devices;
receiving responses from the relevant mobile devices; and
sending information to the mobile device held by the officer in response to the request.

3. The system of claim 1, wherein the method comprises:
receiving a request from the mobile device held by the officer to seek for nearby enemies;
prompting relevant mobile devices for the statuses regarding the locations of the relevant mobile devices, wherein the enemy mobile device, being one of the prompted enemy mobile devices from the server:
is configured to intermittently receive a current location of the enemy mobile device based on the GPS receiver included in the enemy mobile device, in order to increase unpredictability of the exact location of the enemy mobile device for purposes of increasing challenges of seeking the enemies; and
returns the current location of the enemy mobile device to the server, when the enemy mobile device receives the current location, or else returns a prior location of the enemy mobile device detected by the GPS receiver at an earlier time;
receiving responses from the relevant mobile devices, including the statues from the enemy mobile device; and
sending information to the mobile device held by the officer in response to the request, including the location of the enemy mobile device.

4. The system of claim 1, wherein the method comprises:
receiving a request from the mobile device held by the officer to seek for nearby enemies;
prompting relevant mobile devices for the statuses regarding the locations of the relevant mobile devices, wherein the enemy mobile device, being one of the prompted enemy mobile devices from the server:
is configured to only intermittently receive a current location of the enemy mobile device based on the GPS receiver included in the enemy mobile device, in order to increase unpredictability of the exact location of the enemy mobile device for purposes of increasing challenges of seeking the enemies; and
returns the current location of the enemy mobile device to the server, when the enemy mobile device receives the current location, or else returns a prior location of the enemy mobile device detected by the GPS receiver at an earlier time;
receiving responses from the relevant mobile devices, including the statues from the enemy mobile device;
processing the responses, including:
comparing a distance between the location of the enemy mobile device and the mobile device; and
when the distance falls within a certain range, sending location information to the mobile device held by the officer in response to the request to indicate that the enemy mobile device is being within range.

5. The system of claim 1, wherein the method comprises:
receiving a request from the mobile device held by the officer to seek for nearby enemies;
prompting relevant mobile devices for the statuses regarding the locations of the relevant mobile devices, wherein the enemy mobile device, being one of the prompted enemy mobile devices from the server:
is configured to only intermittently receive a current location of the enemy mobile device based on the GPS receiver included in the enemy mobile device, in order to increase unpredictability of the exact location of the enemy mobile device for purposes of increasing challenges of seeking the enemies; and
returns the current location of the enemy mobile device to the server, when the enemy mobile device receives the current location, or else returns a prior location of the enemy mobile device detected by the GPS receiver at an earlier time;
receiving responses from the relevant mobile devices, including the statues from the enemy mobile device; and
processing the responses, including:
comparing a distance between the location of the enemy mobile device and the mobile device;
when the distance falls within a certain range, sending location information to the mobile device held by the officer in response to the request to indicate that the enemy mobile device is being within range;
monitoring the enemy mobile device on behalf of the mobile device, when the distance falls within the certain range, wherein the monitoring includes:
monitoring whether the enemy mobile device is approaching at a direction to the mobile device, by prompting the GPS included in the enemy mobile device;
if the enemy mobile device is approaching at the direction to the mobile device,
sending an alert to the mobile device, wherein the alert includes information regarding the direction approaching by the enemy device with respect to the mobile device; and
seeking help from other friendly mobile devices nearby, and if found, alerting the mobile device regarding the location of the friendly mobile device.
